(19) United States
(12) Patent Application Publication
(10) Pub. No.: US 2006/0121433 A1
(43) Pub. Date: Jun. 8, 2006

(54) System and method for supporting educational software

(76) Inventor: Juliette Adams, New York, NY (US)

Correspondence Address: DICKSTEIN SHAPIRO MORIN & OSHINSKY LLP, 1177 AVENUE OF THE AMERICAS (6TH AVENUE), 41 ST FL., NEW YORK, NY, 10036-2714, US

(21) Appl. No.: 11/265,424

(22) Filed: Nov. 2, 2005

Related U.S. Application Data
(60) Provisional application No. 60/623,851, filed on Nov. 2, 2004.
(60) Provisional application No. 60/623,852, filed on Nov. 2, 2004.

(51) Int. Cl. G09B 7/00

(52) U.S. Cl. 434/323

(57) ABSTRACT

Disclosed is a system and method used for tracking and reporting student performance and for supporting data driven differentiated instruction. The method for managing students using installed software products includes creating a data structure having a hierarchy of levels. Each level comprises one or more entities. In a preferred embodiment, the lowest level of the hierarchy is students. The hierarchy of levels and entities within a particular level are displayed or presented to a user. When a particular entity in the particular level is selected, a list of reports related to the particular level and associated installed software products is presented to the user. Thereafter, a revised report is generated in response to selecting another level or entity in the hierarchy.

### CROSS-REFERENCE TO RELATED APPLICATIONS

This application claims priority to U.S. Provisional Application Nos. 60/623,851 and 60/623,852, both filed Nov. 2, 2004, and incorporated herein by reference in their entirety.

### BACKGROUND OF THE INVENTION

The present invention generally relates to computer systems, and more particularly, to a computerized system and method for navigating through data, for analyzing and reporting student performance, and identifying differentiated instructional material for those students.

### DESCRIPTION OF THE RELATED TECHNOLOGY

Schools use numerous curriculum systems to serve the needs of their departments. The systems currently in place function on a departmental or class level to track students' progress, course activity, student management, classroom management, learning systems, class registration, and the like. Most of these systems involve an initial set up of importing student information from a primary student management or enrollment system.

In addition to traditional classroom instruction, many school districts are instituting computer-supported learning in the classroom. The programs used for computer-supported learning capture valuable data regarding the students' performance. However, the data is often used to inform the one program being used. There is usually little to no sharing of performance data from one curriculum application to another correlation between that program and other programs or other in-class materials that can be used for student instruction. Additionally, each individual's cognitive style of learning is not addressed.

Thus, it would be desirable to have a student management system designed to capture performance data. Additionally, this data should span across all aspects of student instruction so that differentiated instruction for each student or group of students can be created.

Additionally, for reporting purposes, such as those required in the “No Child Left Behind” (NCLB) program, it is desirable that reports are generated on an individual student basis as well class, school, district, or state-wide level.

### SUMMARY OF THE INVENTION

Disclosed is a system and method used for tracking and reporting student performance and support for data driven differentiated instruction.

The method for managing students using installed software products comprises creating a data structure having a hierarchy of levels. Each level comprises one or more entities. In a preferred embodiment, the lowest level of the hierarchy is students. The hierarchy of levels and entities within a particular level are displayed or presented to a user. When a particular entity in the particular level is selected, a list of reports related to the particular level and associated installed software products is presented to the user. Thereafter, a report selected from the list of reports is generated.

The system for managing student users of installed software products comprises a database that stores a data structure comprising a hierarchy of levels, wherein each level comprises one or more entities, and wherein the lowest level comprises students. A display shows the hierarchy of levels and entities within a particular level and a list of reports to the user, and a user interface for selecting an entity in the particular level and a report in the list of reports. A processor generates the list of reports related to the particular level from the data structure and the installed software products and generates the selected report in relation to the entity selected.

The navigation tool allows a user to search in a three dimensional environment. In one embodiment, the navigation system has a three axes, a first axis (x) represents students, a second axis (y) represents reports, roster and profile management, and the third axis (z) changes the scope from student to school to district to state, i.e., the depth of a report. A user can select a student and then select various reports for that student. The user can also select a report and select various students for that report. From any report, the scope can be changed from a particular student to a class, district, or the like. Alternatively, data for a district can be analyzed and the user can drill down to data for a particular student. In a preferred embodiment, the inputs include performance data, rosters and profile managers.

In a preferred embodiment, resources are linked to the reports such that level appropriate materials are suggested based in part on the data held in the reports. In an alternative embodiment, the reports function as a diagnostic tool to identify student weaknesses. Resources are recommended to improve the areas where the student has a weakness. In one embodiment, each individual's cognitive style of learning is addressed.

### BRIEF DESCRIPTION OF THE FIGURES

FIG. 1 is a depiction of a navigation screen;

FIG. 2 is a portrayal of a portion of the navigation screen;

FIG. 3 is an illustration of interrelationships according to the embodiment of the invention;

FIG. 4 is a depiction of the system hierarchy;

FIG. 5 is another depiction of the hierarchical relationship;

FIG. 6 is an illustration of a roster navigation screen;

FIG. 7 is a representation of a list of reports;

FIG. 8 is an illustration of a report;

FIG. 9 is a representation of a printed report;

FIG. 10 is a portrayal of a demographic filter;

FIG. 11 is a depiction of a resource navigation screen;

FIG. 12 is a portrayal of a library navigation screen;

FIG. 13 shows student management within the system; and

FIG. 14 a diagram the system.

### DETAILED DESCRIPTION OF THE INVENTION

The disclosed system and method provides a quick and easy way to navigate through rosters, reports, student performance, student profiles, and the like. In a preferred embodiment, the described management system collects and organizes performance data relating to individual students. The performance data is then preferably aggregated across a larger population. Additionally, in one embodiment, other data such as attendance, bussing requirements, disciplinary actions, and the like can be entered as well as demographic data.

The disclosed management system provides for the management of student rosters and report generation relating at least to student performance at the student, group, classroom, school, district, and state levels. In another embodiment, data can be aggregated across multiple states. The system also aides in locating and recommending additional resources for use in classroom instruction.

It should be noted that the detailed reports assist teachers, faculty members, and administrators to customize student instruction to given standards, as well as assisting and communicating student progress to teachers, administrators, etc. In one embodiment, the system supports the collection and storing of demographic information and enhanced data aggregation to generate reports that meet NCLB requirements.

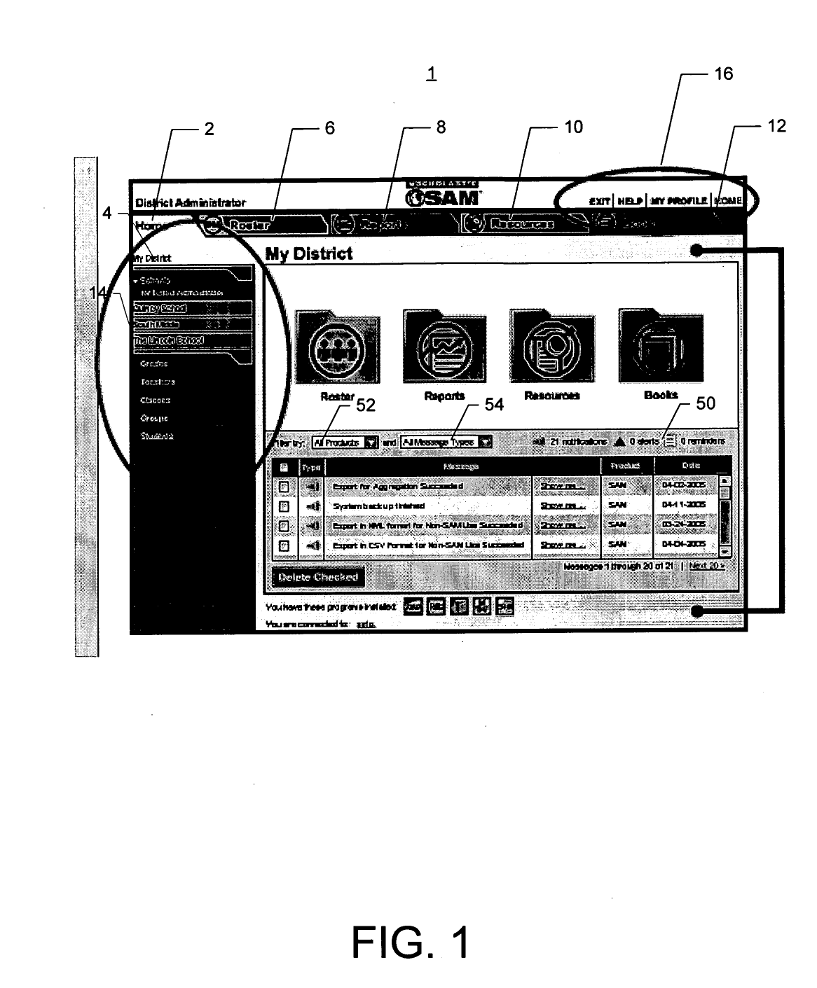

FIG. 1 depicts one embodiment of the main navigation page 1 of the disclosed system. As shown, the current user 2 is displayed. In one embodiment, different users have different levels of access, and as a user's level in the hierarchy of the system changes, the user's ability to edit the data within the system changes. Home tab 4 causes the system to display the main navigation screen including various system functions such as roster 6, reports 8, resources 10, and books 12. Additionally, a SmartBar™ 14 showing a hierarchy of data is part of the display. The SmartBar™ 14 organizes the students from an individual student level up to the highest level being stored. In a preferred embodiment, the highest level is a state-wide database. In a preferred embodiment, the home page includes links to exit the system, get help, and edit your personal profile.

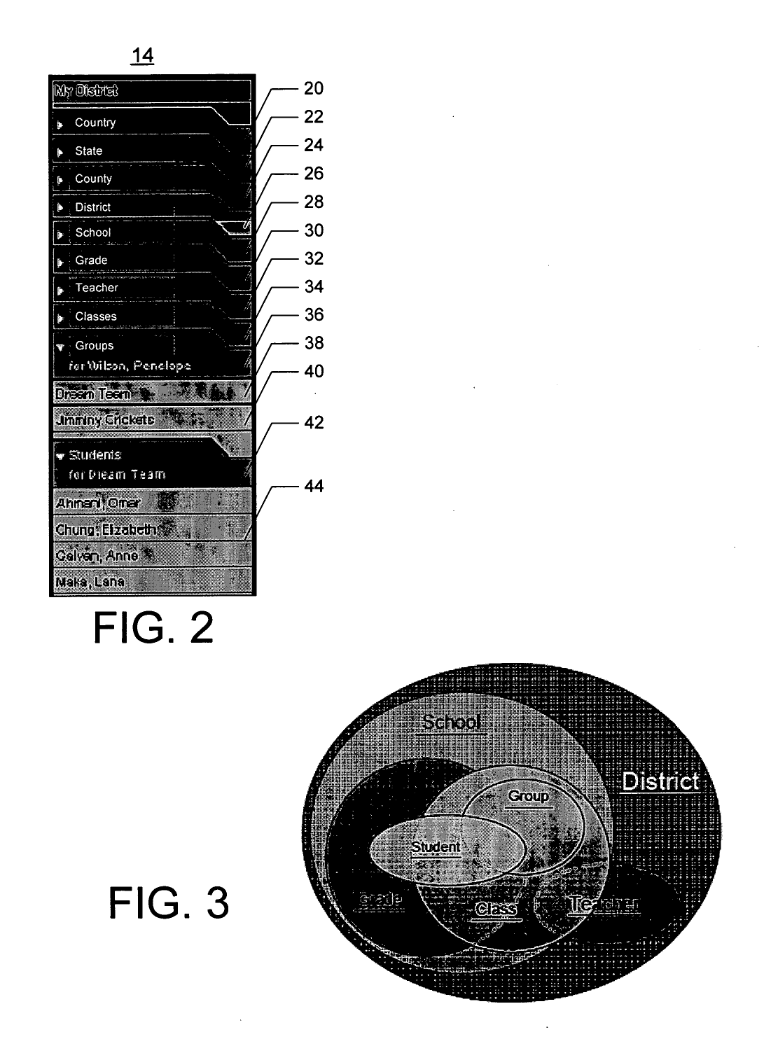

SmartBar™ 14 preferably appears on the left side of the main navigation screen. As shown in FIG. 2, SmartBar™ 14 has tabs that allow user 2 to navigate through the hierarchy from a high level, such as country 20, down to an individual student 44. In a preferred embodiment, when a tab is selected, the members within that tab are displayed. For example, a faculty member (Penelope Wilson) has established two groups. When the groups tab 36 is selected, it expands to display the two groups, Dream Team 38 and Jiminy Crickets 40 created by the faculty member. When the Dream Team tab 38 is selected thereafter, the students 44 comprising the Dream Team 38 are displayed under a heading 42 for the Dream Team. Similarly, if the teacher tab is selected, all of the classes with which the specific teacher is associated appear beneath that teacher's name.

In a preferred embodiment, groups are created from within a class. In another embodiment, groups can be created across classes, grades, districts or the like. In this manner, students requiring special education services, advanced coursework, or other additional services can be grouped within a district, even though they are not in the same class.

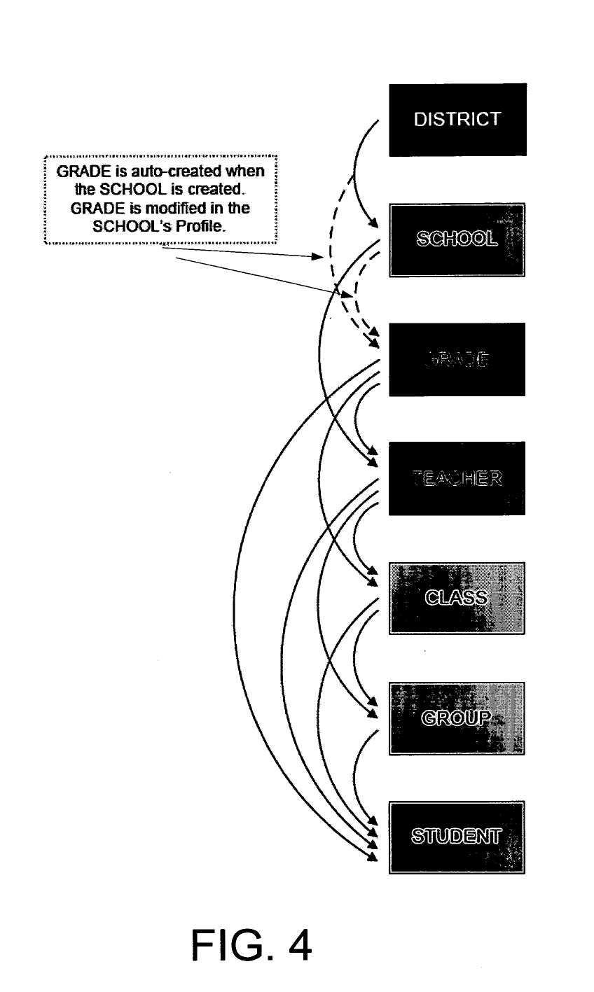

The preferred interrelationships are shown in FIG. 3 in the form of a Venn diagram. As shown, a student is a member of a grade, at least one class, and possibly a group. Groups are subdivisions of classes and, in the preferred embodiment, students in a group are all in the same class. Classes are part of grades, which are part of schools. Schools are within districts. It should be noted that teachers might be assigned to multiple schools. Therefore, as shown, a teacher is partially within the school. FIG. 4 is another depiction of the hierarchical relationship of the members within the system.

SmartBar™ 14 is used to sort profiles and report information for any of the various categories selected. In the preferred embodiment, the SmartBar™ is a hierarchal system such that the cohorts are related in top down manner, and any given tab includes all of the tabs listed beneath it.

Another feature of main screen 1 is message center 50. The message center 50 provides automatic updates regarding student progress, application usage, report generation and the like. Furthermore, in one embodiment, report reminders are automatically generated to ensure that the teacher or other overseeing faculty member is monitoring reports on a timely basis. A faculty member can sort messages by product 52 and message type 54.

Products 52 include any automated teaching and testing systems that are linked to the system, as well as other systems from which data is manually entered. Message types 54 include alerts and acknowledgments, notifications, report reminders, messages from other users or administrators, etc.

It is foreseeable that, there are at least three categories of users. The categories include teachers, administrators and technical coordinators or IT professionals. These groupings can be expanded to include district administrators, as well as district-level technical coordinators.

The first group of users is teachers. Teacher accounts are for classroom-based educators, teaching assistants, reading coaches, tutors and the like. Teachers can analyze student progress and view reports. Teachers utilize the reports to inform differentiated instruction based on the report. In fact, if desired, a teacher can generate student-specific instruction based on a specific student's performance. In a preferred embodiment, performance is normalized by a lexile scale. In other words, performance data for various computer-supported learning programs or traditional in-class teaching products is conformed to a single scale. The system of the present invention provides feedback such that the child-specific instruction is suggested across a broad spectrum of instructional packages. In other words, if a student's report denotes that the student is having difficulty reading words containing long “A”s and identifying passage themes, the system recommends phonetic lessons in a first instructional package, as well as reading review units to assist the student in identifying the theme of the passage. In an alternative embodiment, the system utilizes the reports to prepare differentiated instruction based on the reports.

Teachers have the ability to create groups within their classes. In a preferred embodiment, a teacher can only group students within a given class. However, in an alternative embodiment, a teacher or other administration can group students across several classes, schools or states. In another embodiment, the system groups individuals based on performance, abilities, or the like. In one embodiment, an administrator or teacher sets the pool of students from which the system can create groups. The pool of students can be a class, a grade, a school, a district, or the like.

The second group of users is at the administrative level, such as school administrators or district administrators. These users can generate aggregate reports, reports across classes, schools, districts and the like. Moreover, school administrators can generate yearly reports and all of the required NCLB reports required for NCLB compliance.

The third group of users is the technical coordinators. The technical coordinators manage the overall system. In the preferred embodiment, the system is a highly-configurable platform. Thus, various components can be stored on different servers and mainframes. All of these separate components can communicate with one another to transfer data between and among themselves. In a preferred embodiment, the day-to-day components of the system are hosted locally, but the data is stored in a central location for the convenience of generating aggregated data reports. Alternately, the data is stored locally and exported to a central location where it is aggregated for report generation.

In an alternative embodiment, parents or guardians comprise an additional group of users. Parents or guardians are able to log into the system and review their child's performance. It should be noted that other student's records would not be accessible. However, reports comparing their child to the class or other larger group could be generated.

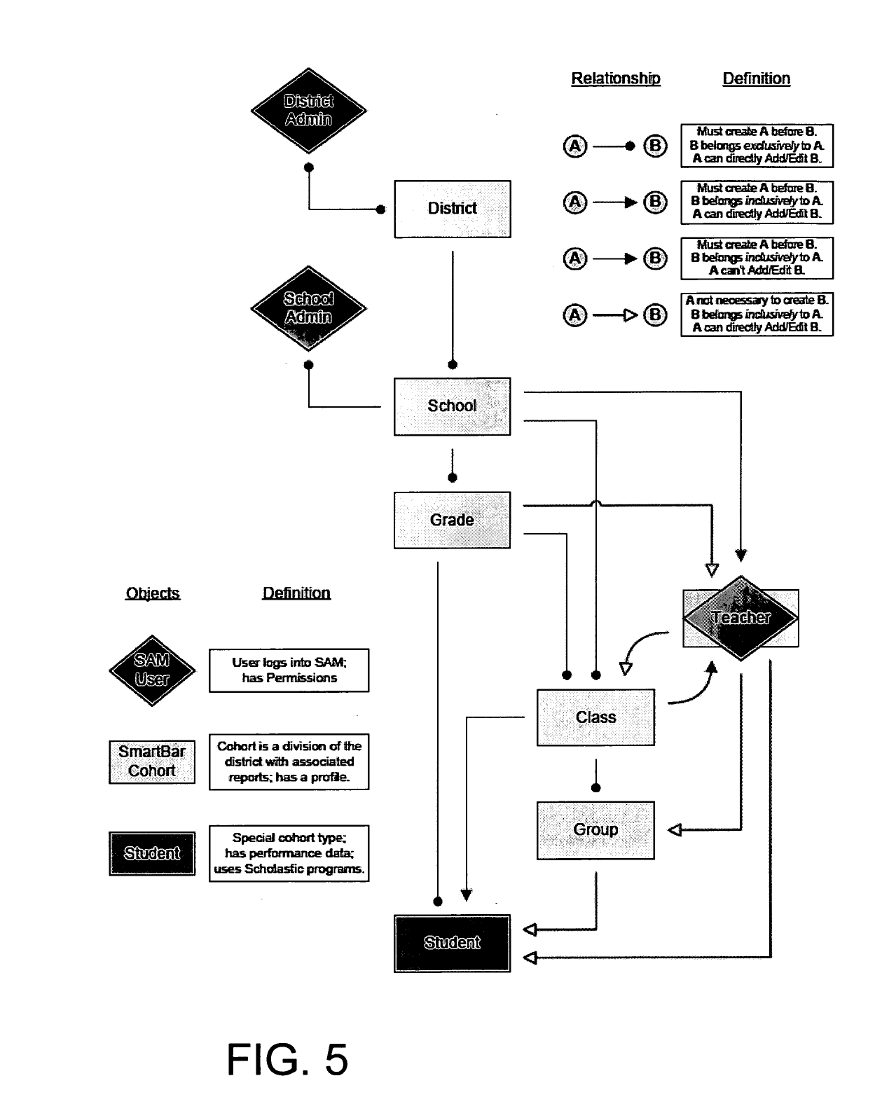

FIG. 5 is depiction of the system hierarchy. As shown, in descending order, initially a district is established. Thereafter, schools are added to the district; grades and added to the school; and classes are added to the grade. Once a school is created, the school's administration can be created. In one embodiment, classes are created from the school level. Once the grade and class are created, students can populate the grade, class, and group. It should be noted that the system is not driven by the selection of a teacher. In fact, once the school, grade, and class are created and the students are populated within those headings, a teacher can then be assigned to the grade, class, or group.

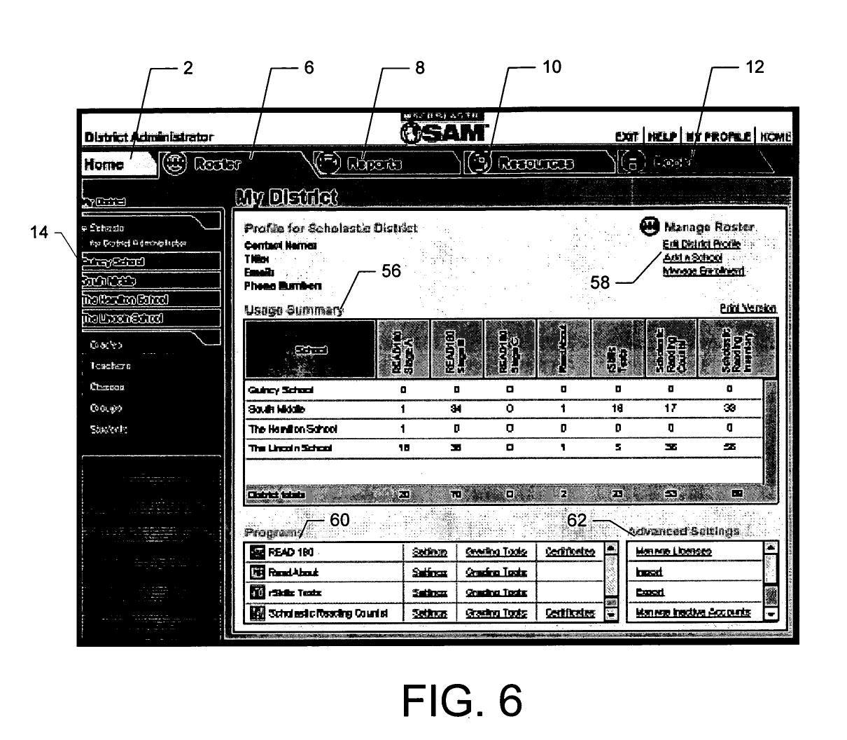

FIG. 6 is a depiction of a roster navigation screen. As shown, the profile for a selected, class, student or group will appear in the main display window. In a preferred embodiment, each profile screen contains contact information and relevant data such as school, grade, class, etc.

Section 56 is a usage summary. At the school level, usage summary 56 shows each of the software packages in use and, preferably, the number of licenses available at each location. The program's area 60 provides for program management, student enrollment, and grading options. Section 62 provides advanced settings for the system. The advanced settings allow administrators or other users with specific rights to import, export, and back up data. Additionally, the advanced settings provide for tracking, maintenance, management of inactive accounts, etc. Finally, the roster Tab 6 allows the user to manage the class district school or group roster. In addition, profiles for schools, teachers, students and groups can be added or subtracted using the manage roster tool.

The roster tab is also the area in the system where school demographics are recorded. In this manner, AYP reports can be generated using the demographic data added per school.

FIG. 6 is a depiction of the screen when roster tab 6 is selected. As shown, roster 6 tab is a district administrator's view. However, a teacher has a similar view when selecting the roster tab 6. The teacher will view classes under the usage summary Heading 56 in place of schools which are displayed for district or school administrators. From the class view, a teacher can create subgroups. Summaries for these subgroups can also be displayed under the roster tab.

Just as a school administrator can work on the school level, and teachers have the ability to work on the class level, the teachers can also work with the classes on an individual level. Once an individual student is selected, a usage summary for the student is generated. The usage summary provides the student's progress, as well as recent data points and high-level progress. In one embodiment, comparative reports can be generated comparing the student to standard lexile scores, other students in the class, other students in the school, other students in the county, or other students in a subgroup.

Using the grading tools in Section 60, a teacher or administrator can evaluate a student's performance. The reports include detailed information about time-on-task reading progress, time-on-task math progress, reading and math progress in a variety of areas with respect to a variety of skills.

In a preferred embodiment, there are six types of reports that can be generated on Reports Tab 8. The reports include progress monitoring, diagnostic reports, instructional planning reports, alerts and acknowledgment reports, school-to-home reports and management reports.

Progress reports provide information on skilled progress and time spent on various activities. These reports keep teachers up to date on how an individual student, class, or group is doing over a time period. These same reports are accessible by school administrators so that they may obtain the same data.

Diagnostic reports provide information on students' strengths and weaknesses in specific areas. These reports assist teachers in differentiating instruction to meet a particular student's individual needs. Additionally, these reports can be varied by the SmartBar™ selection so that a report can easily be tailored to go from a single student all the way to the state or country level.

Instructional planning reports assist teachers in planning targeted, data-driven instruction. In these reports, teachers group students according to their skill needs or according to the activities or topics the students are working on. Alternatively, students are grouped by the system based on the student's skills or similar data from tests quizzes, and the like.

Alert and acknowledgment reports relate to automatic updates to teachers about milestones. In addition, the teachers are notified of student achievements. Each teacher can view notifications in the message center. In a preferred embodiment, teachers can select alert and notification points.

The school-to-home reports or letters to parents or guardians relates to student-specific progress information. Finally, the management reports provide lists of enrolled students and all teachers using various programs and other basic program report packages.

It should be noted that reports could be run for an individual student, a classroom, district, or state. Moreover, reports can be generated for specific time periods, such as the current school year, the grading period, a given week, specific days and custom ranges. In one embodiment, the report can be saved so that it can be re-run for different time periods. Additionally, once a report is run for a student by merely pushing a different tab in the SmartBar™, the report will be run in and for that category. In other words, if a progress report were run for a class, selecting the district tab would run the same report for similarly-situated students in the district. In an alternate embodiment, when the district tab is selected, the same report is run for all of the students in the district. Likewise, when a given cohort, e.g., individual, class, district, etc., is selected, different reports are generated by selecting the desired report.

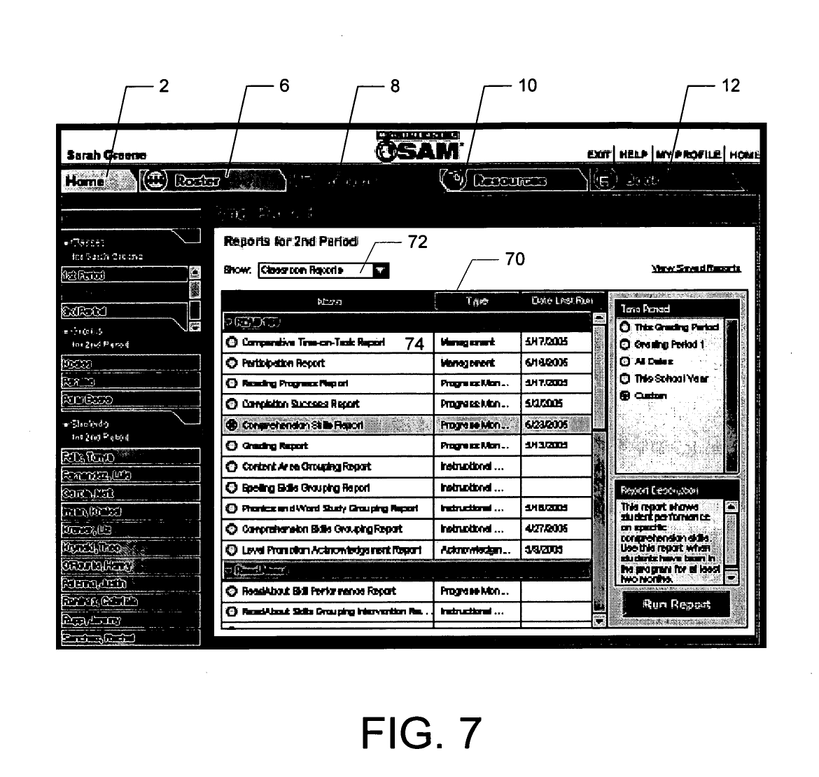

As shown in FIG. 7, a list of reports 70 is displayed. The report list 70 is populated based in part on the level selection in SmartBar™ 14 and the classification selected from drop-down menu 72. Drop-down menu 72 displays various filters for reports such as classroom, student, all reports, and the like.

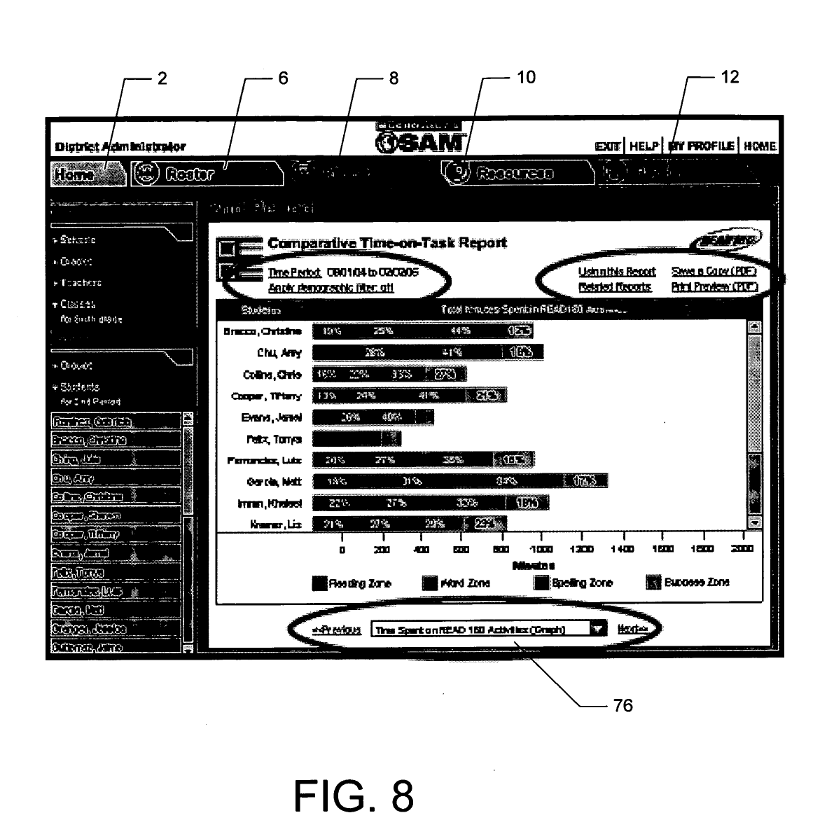

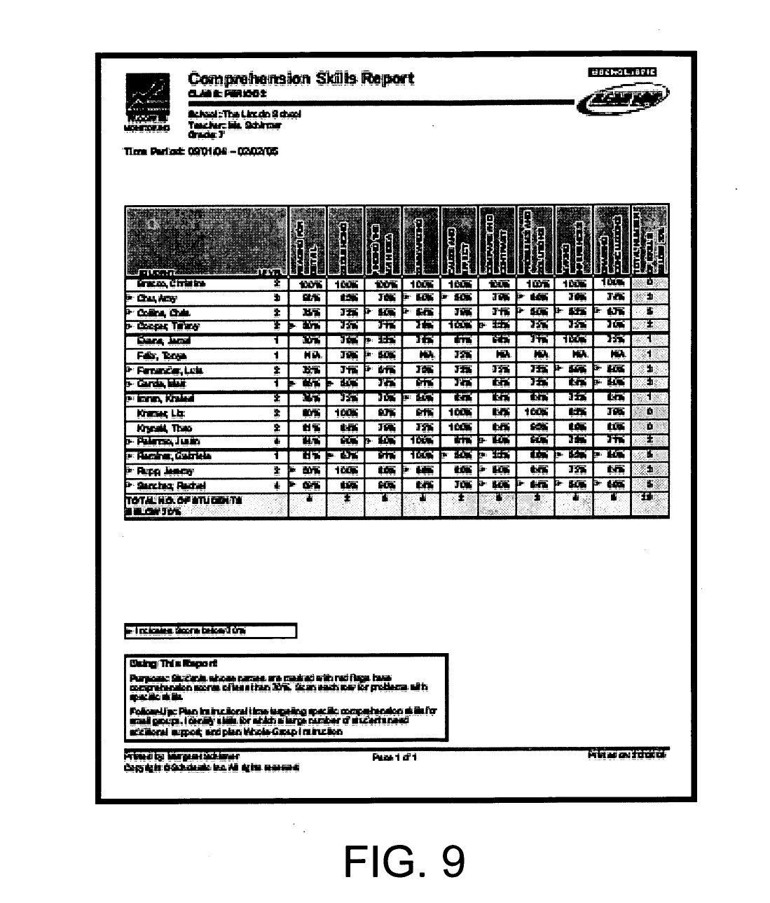

After a user selects a report, such as “comparative time on task” 74, a report screen is generated as shown in FIG. 8. The date range for each report can be customized as well as the students for which the report is being generated. The reports screen allows the user to sort information in the report by column, access resources related to your report, vary the time period of the report, and use the demographic filter. Additionally, the user can view related reports, print a copy of the report, or save the report. A drop-down menu 76 allows the user to run different using the same SmartBar™ selection.

After a report is selected for a first cohort in SmartBar™, i.e., a class, the user can select another cohort, i.e., a grade, and the report is updated to reflect the new cohort. Thus, it is easy to navigate through reports for the various cohorts in the system.

Using the disclosed navigation system, a user can easily navigate to a screen that displays related resources. A variety of resources is available to support instruction related to individual students or your classes. These resources are directly related to skill areas identified in the reports. Additionally, in a preferred embodiment, the resources are accessible from the report. Alternatively, a user can select resource tab 10 to access related resources.

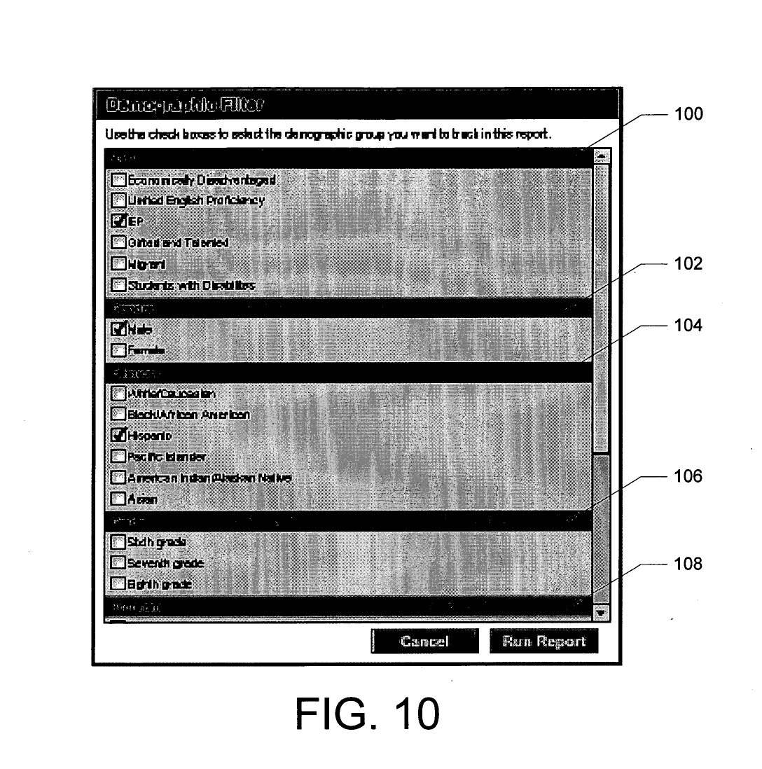

The system provides a demographic filter as shown in FIG. 10. In a preferred embodiment, the demographic filter can be used with any report. When the student profiles are input, they contain demographic data that supports administrators in running reports based on NCLB reporting categories. This data helps districts and schools to track, monitor, and demonstrate Adequate Yearly Progress (AYP).

The Demographic Filter provides focused reporting based on various categories, including AYP criteria 100, gender 102, ethnicity 104, and grade 106. In one embodiment, the user can also select computer-supported instructional programs 108. Alternatively, programs 108 also include non-computer programs such as a multisensory reading program, and the like.

AYP criteria make distinctions between students with economic disadvantages, gifted and talented students, students with limited English proficiency, students with disabilities, and migrant students. Ethnicity is used to identify students from various ethnic backgrounds, like Asian, Native American/Native Alaskan, Pacific Islander, African American, and Caucasian. Grade filters are used to filter the reports based on which grade the student or class is associated with or which grade is selected. In a preferred embodiment, the programs 108 include, but are not limited to Scholastic Program: READ 180, ReadAbout, Scholastic Reading Counts!, SRI, or any other Scholastic program.

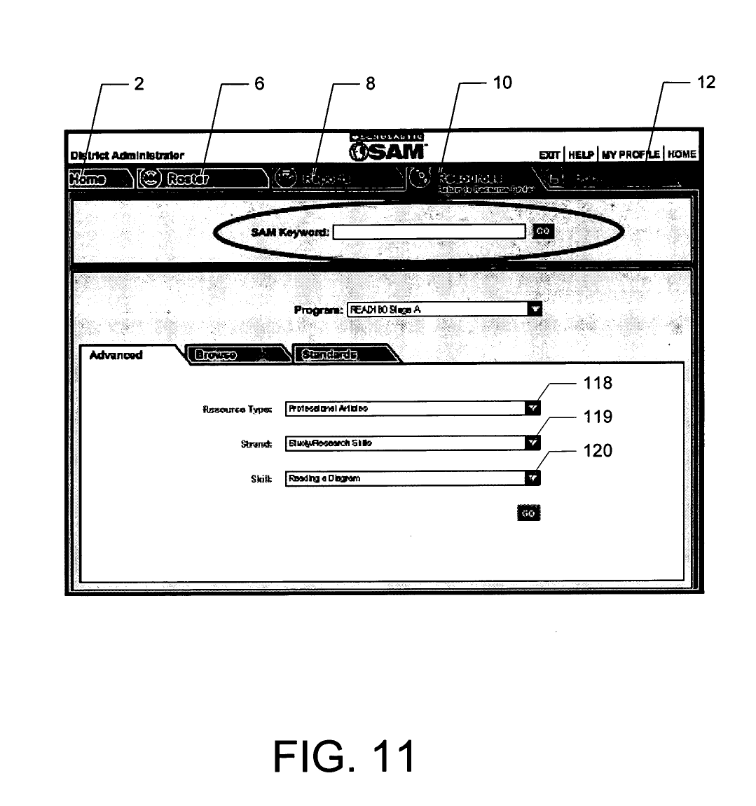

The disclosed system provides access to a variety of instructional resources. The resources are accessed through resource tab 10, as shown in FIG. 11. Resources provide additional support for software-based activities and classroom-based instruction. For example, reading passages can be printed as homework assignments, or to provide a lesson to students as extra practice to develop skills learn on the software or in class. Resources can be used for the classroom and individual students.

The resource finder depicted in FIG. 11 is a tool for locating resources. To access the resource finder, a user selects resource tab 10. The resource finder preferably has the following features to help you narrow your searches quick keyword search 110, advanced search 112, browse 114, and standards 116.

Keyword search 110 allows you to search for resources using keywords. In a preferred embodiment, the computer-supported materials are indexed. In another embodiment, all of the in-class materials are indexed. In this manner, a keyword search can be performed on the material.

The advanced search function 112 enables a user to tailor the resource search by resource type 118, strand 119, and skill 120. In one embodiment, the search can also include computer based programs. In a preferred embodiment, the resource type 118, strand 119, and skill 120 criteria are set using drop-down menus.

The Browse function 114 enables a user to browse for types of resources associated with small or whole group instruction, individual students, and by program. In a preferred embodiment, the Browse feature that allows a user to search for resources associated with specific needs such as by specific topics or specific in class need. For class, group, or individual instruction, a user can browse lessons, practice pages/BLMs, certificates, and READ 180-specific resources. For individual students the resources include specific instruction, such as vocabulary lists, math drills, and the like.

The standards lookup 116 provides a user with state standards. To search for a specific standard a user selects the desired state and searches for related standards within the state or at a national level. In this manner, teachers and administrators can stay abreast of grade level requirements as well as NCLB requirements, and the like.

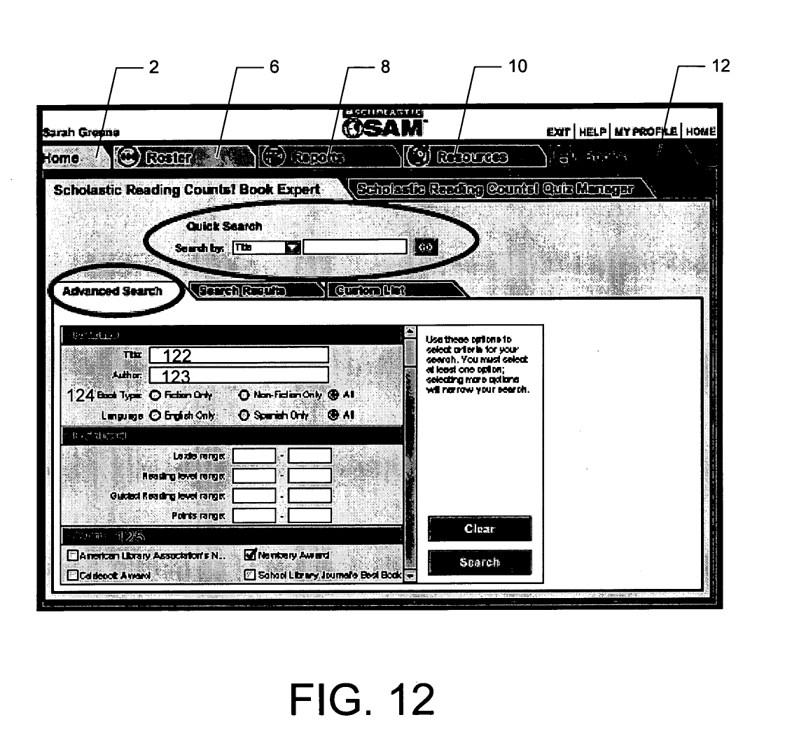

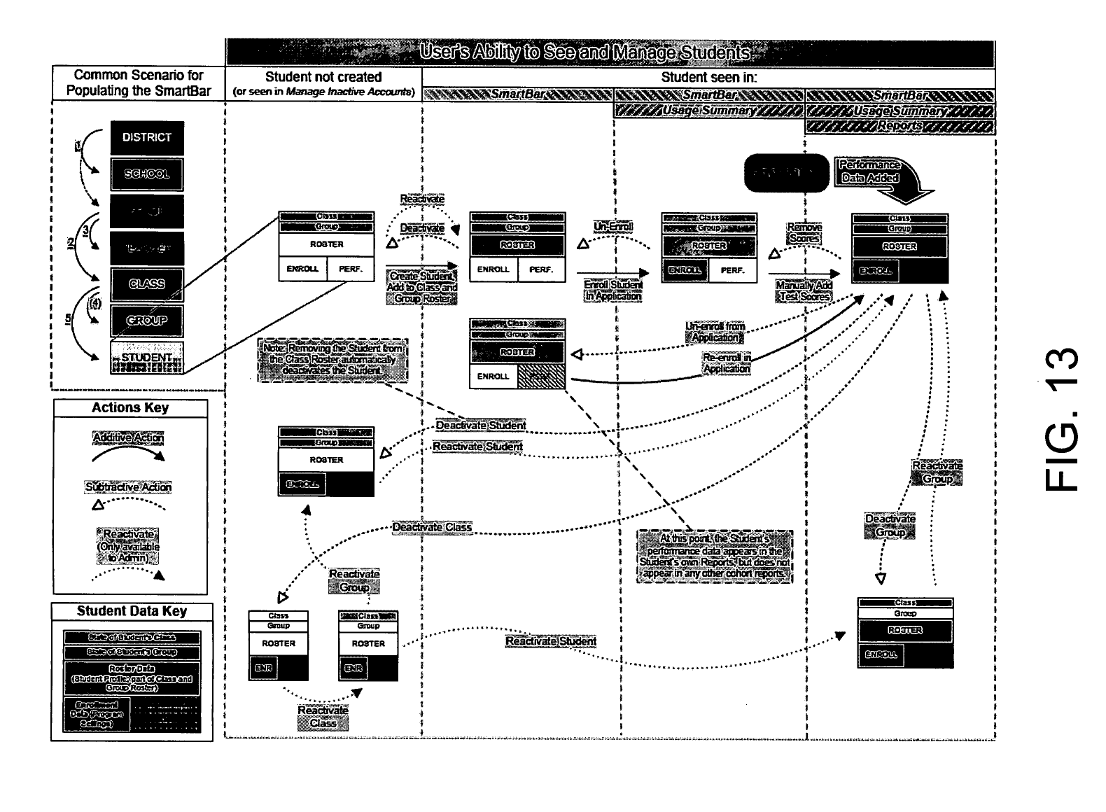

The book expert, shown in FIG. 12, is accessed by selecting tab 12. The book expert searches library contents to find books that match curriculum needs. In a preferred embodiment, the library is the Scholastic Reading Counts! library. The book expert provides for the assignment of quizzes to help measure students' reading progress.

To access the book expert search screen, the books button shown in FIG. 1 or tab 12 is selected. In the book expert, books can be searched for by title 122, author 123, Lexile, or other descriptive categories. A quick search feature allows a user to search, for example, by title or author's last name to find different book titles. Search results are displayed on a search results screen. The results can be sorted by book/quiz title, author, Lexile level, reading level, guided reading level (GRL), point value, words, genre, or number of copies in your library, or the like.

Criteria to search includes book information such as author 123, title 122, book genre 124 (fiction, historical fiction, poetry, myths, legends or nonfiction), language, or the like. Additionally, the search can be tailored to a specific level. Level can be designated by one or more of students' or classes' lexile, grade, reading level, Guided Reading Level (GRL), material, lexile, and point ranges. In one embodiment, awards 125 that books have received, such as Newbery and State Book Awards are listed.

In one embodiment, a user can search books used to address specific comprehension skill issues. Additionally, if a user is using a book to highlight cultural units, books that relate to specific cultural backgrounds can be located. Books can also be found that relate to other in class topics such as conservation, endangered species, or the like.

In a preferred embodiment, the system communicates with other computer-supported learning tools. These tools provide data regarding student performance, progress, and the like. The system is preferably adapted to analyze this data and recommend additional material for the student. The additional material may be remedial, grade level, or advanced. Preferably, all of the materials are normalized to one scale, i.e., a lexile scale.

Lexile scores correlate to different grade levels. Students and materials are assigned lexile values. The lexile scale creates an educational landscape that is consistent from first grade through high school. A student's lexile value is based on testing whereas material is deemed to be of a specific level. Thus, a lexile score places a student on the educational landscape. In this manner, a student can be matched with lexile appropriate work.

Once a student, group of students, class, or the like has associated data in the system, the teacher can easily locate data-driven differentiated instruction material. This lesson plan, including suggested material, is based on the students' lexile score and other relevant performance to date. In a preferred embodiment, the differentiated instruction material is designated by the system. It should be noted that preferably, data from various computer-supported learning programs is used to identify the differentiated learning material. Additionally, the differentiated learning material is drawn from multiple sources such as computer-supported learning programs and in-class non-computer bases learning systems.

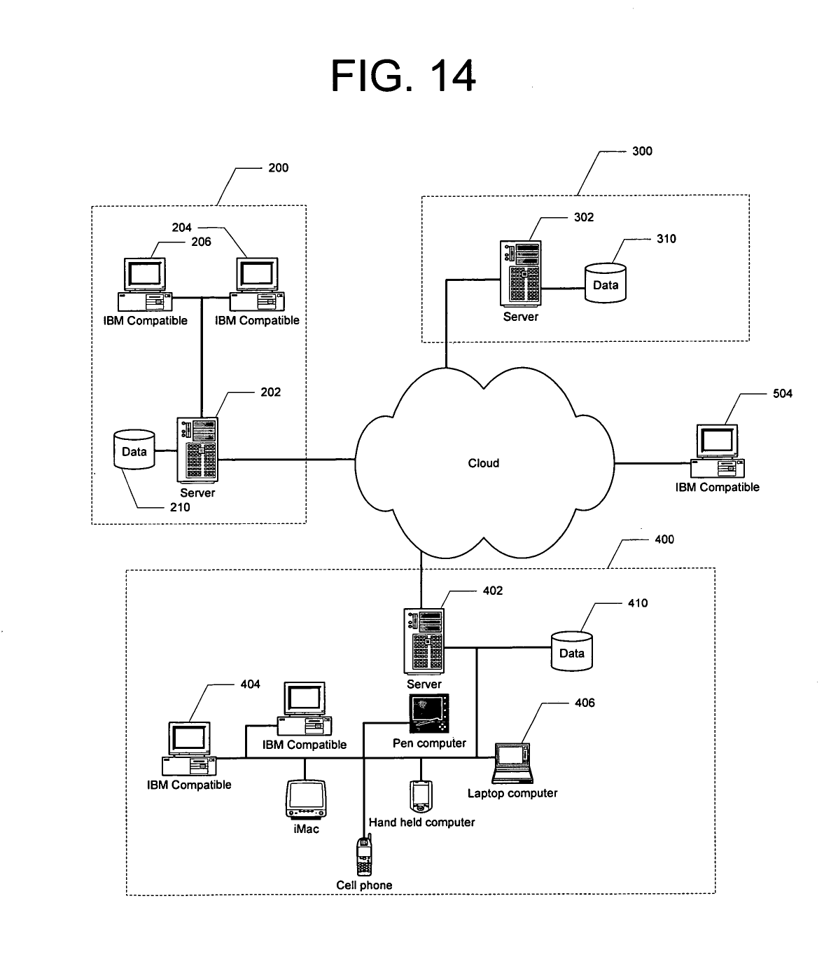

FIG. 14 depicts the environment in which the system and method operate. In a first embodiment, schools 200 and 400 each have self contained systems. Each system includes a server 202, 402 and database 210, 410. The local systems include a data acquisition component, and analysis section and a feedback generation section. Students' generated data is preferably stored on database 210, 410. In a preferred embodiment, a system exists at a district level 300. Data from individual schools 200 and 400 is transmitted to server 302 for aggregation, reporting purposes, and the like.

In another embodiment, a user 504 can access the system via the internet, VPN, dial-in, or the like. In this embodiment, the student 504 accesses the student's home-school server 402 or the centralized system 300. It should be noted that the entire system can be on any one server or various portions of the system can be on different servers that communicate with one another.

The present invention has been, in part, described herein in terms of functional block components, code listings, optional selections, and various processing steps. It should be appreciated that any number of hardware and/or software components configured to perform the specified functions may realize such functional blocks. For example, the present invention may employ various integrated circuit components, e.g., memory elements, processing elements, logic elements, look-up tables, and the like, which may carry out a variety of functions under the control of one or more microprocessors or other control devices.

Similarly, the software elements of the present invention may be implemented with any programming or scripting language such as C, C++, C#, Java, COBOL, assembler, PERL, or the like, with the various algorithms being implemented with any combination of data structures, objects, processes, routines or other programming elements.

Further, it should be noted that the present invention may employ any number of conventional techniques for data transmission, signaling, data processing, network control, and the like. In a preferred embodiment, the system is deployed via the Internet.

It should be appreciated that the particular implementations shown and described herein are illustrative of the invention and its best mode and are not intended to otherwise limit the scope of the present invention in any way. Indeed, for the sake of brevity, conventional data networking, application development, and other functional aspects of the systems (and components of the individual operating components of the systems) may not be described in detail herein. Furthermore, the connecting lines shown in the various figures contained herein are intended to represent exemplary functional relationships and/or physical or virtual couplings between the various elements. It should be noted that many alternative or additional functional relationships or physical or virtual connections may be present in a practical electronic data communications system.

As will be appreciated by one of ordinary skill in the art, the present invention may be embodied as a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described below with reference to block diagrams and flowchart illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks.

These computer program instructions described herein may also be stored in a computer-readable memory that can direct a computer or other programmable data processing apparatus to function in a particular manner, such that the instructions stored in the computer-readable memory produce an article of manufacture including instruction means that implement the function specified in the flowchart block or blocks. T he computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems that perform the specified functions or steps, or suitable combinations of special purpose hardware and computer instructions.

One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, de-encryption, compression, decompression, and/or the like.

The scope of the invention should be determined by the appended claims and their legal equivalents, rather than by the examples given herein. For example, the steps recited in any method claims may be executed in any order and are not limited to the order presented in the claims. Moreover, no element is essential to the practice of the invention unless specifically described herein as “critical” or “essential.”

In the specification, the term “media” means any medium that can record data therein. The term “media” includes, for instance, a disk shaped media for such as CD-ROM (compact disc-read only memory), magneto optical disc or MO, digital video disc-read only memory or DVD-ROM, digital video disc-random access memory or DVD-RAM, a floppy disc, a memory chip such as random access memory or RAM, read only memory or ROM, erasable programmable read only memory or E-PROM, electrical erasable programmable read only memory or EE-PROM, a rewriteable card-type read only memory such as a smart card, a magnetic tape, a hard disc, and any other suitable means for storing a program therein.

A recording media storing a program for accomplishing the above mentioned apparatus maybe accomplished by programming functions of the above mentioned apparatuses with a programming language readable by a computer or processor, and recording the program on a media such as mentioned above.

A server equipped with a hard disk drive may be employed as a recording media. It is also possible to accomplish the present invention by storing the above mentioned computer program on such a hard disk in a server and reading the computer program by other computers through a network.

As a computer processing device, any suitable device for performing computations in accordance with a computer program may be used. Examples of such devices include a personal computer, a laptop computer, a microprocessor, a programmable logic device, or an application specific integrated circuit.

While this invention has been described by reference to preferred embodiments, it should be understood that numerous changes could be made within the spirit and scope of the inventive concepts described. Accordingly, it is intended that the invention not be limited to the disclosed embodiment, but that it have the full scope permitted by the language of the following claims.

I claim:

1. A computerized system for analyzing students' performance data and providing differentiated instruction based on the students' performance data, the system comprising:
a data acquisition section configured to receive the students' performance data indicative of each of the students' performance on specified material;
an analysis section adapted to analyze the received students' performance data; and
a feedback generation section configured to receive analysis data from the analysis section and generate a course of instruction for each of the students.

2. The system of claim 1, wherein the data source is a computer-based learning module.

3. The system of claim 1, wherein the data source is a graduated instructional program.

4. The system of claim 1, wherein the student's performance data is indexed by state, district, school, teacher, class, group, or student.

5. The system of claim 4, wherein the student's performance data comprises a score achieved by the student on a quiz or a test.

6. The system of claim 5, wherein the student's performance data is lexile data.

7. The system of claim 5, wherein the performance data is any recorded interaction by the student with the instructional application.

8. The system of claim 7, wherein the analysis section determines a specific learning problem of at least one of the students and generates a remedial recommendation.

9. The system of claim 7, further comprising a database wherein the data is stored in the database.

10. The system of claim 9, wherein the database is a centralized database.

11. A method for analyzing students' performance data and providing differentiated instruction based on the students' performance data, the method comprising:
receiving the students' performance data indicative of each 5 of the students' performance on specified material;
analyzing and normalizing the received students' performance data; and
generating a recommended set of instructional material for at least one of the students based on analyzed data.

12. The method of claim 11, wherein the data source is a computer-based learning module.

13. The method of claim 11, wherein the data source is an instructional program.

14. The method of claim 11, further comprising indexing the student performance data by state, district, school, teacher, class, group, or student.

15. The method of claim 14, wherein the performance data comprises a score achieved by the student on a quiz or a test.

16. The method of claim 14, wherein the performance data is any recorded interaction by the student with an instructional application.

17. The method of claim 16, wherein the performance data is lexile data.

18. The method of claim 17, further comprising:
determining a specific learning problem of at least one of the students; and
generating a remedial recommendation.

19. A data navigation method, comprising:
creating a data structure comprising a hierarchy of levels, wherein each level comprises one or more entities, and wherein the lowest level is an individual;
presenting the hierarchy of levels and entities within a particular level;
selecting an entity in the particular level;
presenting a list of reports related to the particular level;
generating a report selected from the list of reports; and
generating a revised report in response to selection of another level or entity in the hierarchy.

20. The method of claim 19, wherein a data source for the data used to generate the reports is a computer-based learning module.

21. The method of claim 19, wherein a data source for the data used to generate the reports is a graduated reading program.

22. The method of claim 20, further comprising indexing the data by state, district, school, teacher, class, group, or student.

23. The method of claim 21, further comprising indexing the data by district, school, teacher, class, group, or student.

24. The method of claim 20, wherein the performance data comprises a score achieved by the student on a quiz or a test.

25. The method of claim 21, wherein the performance data comprises a score achieved by the student on a quiz or a test;
or any recorded interaction by the student with an instructional application.

26. The method of claim 22, further comprising:
determining a specific learning problem of at least one of the students; and
generating a remedial recommendation.

27. A system for managing student users of installed software products, comprising:
a database that stores a data structure comprising a hierarchy of levels, wherein each level comprises one or more entities, and wherein the lowest level comprises students;
a display that shows the hierarchy of levels and entities within a particular level and a list of reports;
a user interface for selecting an entity in the particular level and a report in the list of reports; and
a processor that generates the list of reports related to the particular level from the data structure and the installed software products and generates the selected report in relation to the entity selected, wherein
a revised report is generated in response to selecting another entity in the hierarchy.
